(19) United States
(12) Patent Application Publication
(10) Pub. No.: US 2002/0011435 A1
(43) Pub. Date: Jan. 31, 2002

(54) Oil cleaning filter

(76) Inventor: Anatoliy Nikolaevich Koltunov, Poltava (UA)

Correspondence Address: John B. Hardaway, III, NEXSEN PRUET JACOBS & POLLARD, LLC, P.O. Box 10107, Greenville, SC, 29603, US

(21) Appl. No.: 09/915,050

(22) Filed: Jul. 25, 2001

(30) Foreign Application Priority Data
Jul. 28, 2000 (UA) UA2000074558

(51) Int. Cl. B01D 27/10; B01D 27/14

(52) U.S. Cl. 210/132; 210/136; 210/323.2; 210/450

(57) ABSTRACT

The knock-down structure of the filter comprises a body with a cover and a filtering element with a bypass valve and an anti-drain valve, a filtering element of the bypass valve and a spring, arranged coaxially inside the body. The body is provided with an annular groove accommodating a split locking ring. On the external cylindrical surface of the cover at least one annular groove is provided in which a sealing gasket and a projection are disposed, said projection interacting with said split locking ring. The one-piece structure of the filter does not comprise a locking ring and projection, the body having a beading made at the end edge thereof and directed toward the interior of the body, the cover being made likewise with a sealing gasket, the external end surface of the cover interacting with the beading of the body.

### FIELD OF THE ART

The claimed invention relates to automobile industry and more particularly to the production of devices for filtering oils. The proposed structure of an oil cleaning filter may find application in automobile, tractor and aircraft internal combustion engines.

### BACKGROUND OF THE INVENTION

A one-piece filter for cleaning oil in internal combustion engines is known in the art, this filter comprising a body and a cover joined by beading. The body with the cover accommodates a spring-loaded filtering element provided with an anti-drain valve and a bypass valve (“Catalog of Parts for VAZ Passenger Car”, Moscow, Mashinostroenie Publishers, 1984).

Such filters are compact and easily replaceable. The body of the filter is thin-walled and made by press molding. However, the filter having such a structure is not reusable. As a rule, after the car has run 10 thousand km, the filtering element fails and the filter is subject to replacement and utilization, though the body and other parts and units of the filter are not worn out and are fit for further operation. This involves annual losses of high-quality metal amounting to many million tons.

Practice has also shown that in one-piece filters it is difficult to provide tightness of the joint between the body and the cover, and leakages are developed rather often in such filters.

Furthermore, filters in which the body and cover are joined by beading practically are not liable to utilization, whereas at present their annual production amounts to about 4.5 milliard pieces. As a result, the pollution of the environment is catastrophic.

Also known in the art is an oil cleaning filter (UA, A 1413). This design, as the most close in terms the technical solution and functional purpose, is adopted as the prototype. This filter comprises a body connected with a cover, a filtering element (the main filtering element) with a bypass valve and an anti-drain valve and a filtering element of the bypass valve and a spring arranged coaxially in the filter body.

In the structure of the filter the connection of the body and cover with the help of a spline coupling and the packing are very complicated and require large expenditures in their embodiment, this leading to a sharp rise in prices for the filter even if it is mass produced. BRIEF DESCRIPTION OF THE INVENTION

It is an object of the invention to provide an oil cleaning filter which features such connection of the body with the cover and such arrangement of parts and units for both a knock-down and one-piece filter, which will provide the possibility of easy assembling and disassembling the filter for ensuring rapid and high-quality utilization of spent filters, filtering elements, oil and other parts and units, as well as the possibility of reusing the filter.

Another object of the invention is to raise the quality of oil cleaning and to enhance the reliability of the filter operation.

Said objects are accomplished by that the proposed oil cleaning filter comprising a body connected with a cover and a filtering element with a bypass valve and an anti-drain valve, a filtering element of the bypass valve and a spring arranged coaxially inside the body, according to the invention comprises a split locking ring arranged in an annular groove of the body at the end edge thereof, and the cover on the external cylindrical surface comprises at least one annular groove in which a sealing gasket and a projection are disposed, the projection interacting with the split locking ring. Such structure of the body and cover provides the possibility for their releasable connection.

The filter of the above-said design can be embodied without the split locking ring and projection, the filter body at the end edge thereof comprising a beading directed toward the interior of the body, and the cover on the external cylindrical surface comprising at least one annular groove with a sealing gasket and an external end surface interacting with the beading of the body. Such structure provides the one-piece embodiment of the filter body.

Both embodiments of the filter can be provided, in addition to the main filtering element, with an additional parallel-flow filtering element whose filtering fineness amounts to 39-50% of the rated filtering fineness of the main filtering element, and can also comprise a safety valve with the pressure differential of 2-2.2 (MPa) atmospheres, ensuring oil supply to friction pairs in the case all the filtering elements are fouled.

The proposed filter having a knock-down or one-piece structure provides a reliable tight connection between the body and cover, as well as maximum simple assembling and disassembling, so that utilization processes of spent filters can be automated. Mounting a safety valve on the filtering element of the bypass valve with the pressure differential of 2-2.2 (MPa) atmospheres, e.g., with a gauze filtering element in the form of a membrane or a small cylinder disposed in front of or after the safety valve or after the bypass valve, makes it possible to provide reliable operation of the engine, especially under the conditions of rural areas or desert.

The provision of the parallel-flow filtering element whose filtering fineness amounts to 39-50% of the rated filtering fineness of the main filtering element makes it possible to additionally clean oil from fine fractions, whereby the service life of the engine is increased markedly.

### BRIEF DESCRIPTION OF DRAWINGS

The invention will be better understood when read in conjunction with the accompanying drawing, in which:

FIG. 1 shows a knock-down filter in section (general view);

FIG. 2 shows the structure of the body and the cover of a knock-down filter, providing their connection and sealing;

FIG. 3 shows a one-piece filter in section (general view);

FIG. 4 shows the structure of the body and the cover of a knock-down filter, providing their connection and sealing;

FIG. 5 shows the structure of a knock-down filter with a safety valve and a parallel-flow filtering element.

### DETAILED DESCRIPTION OF THE INVENTION

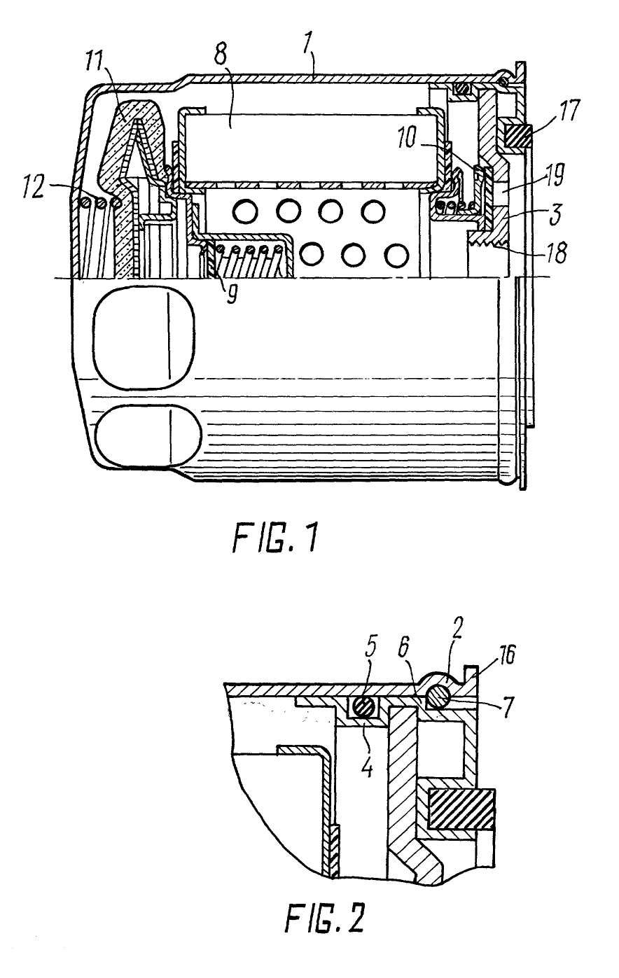

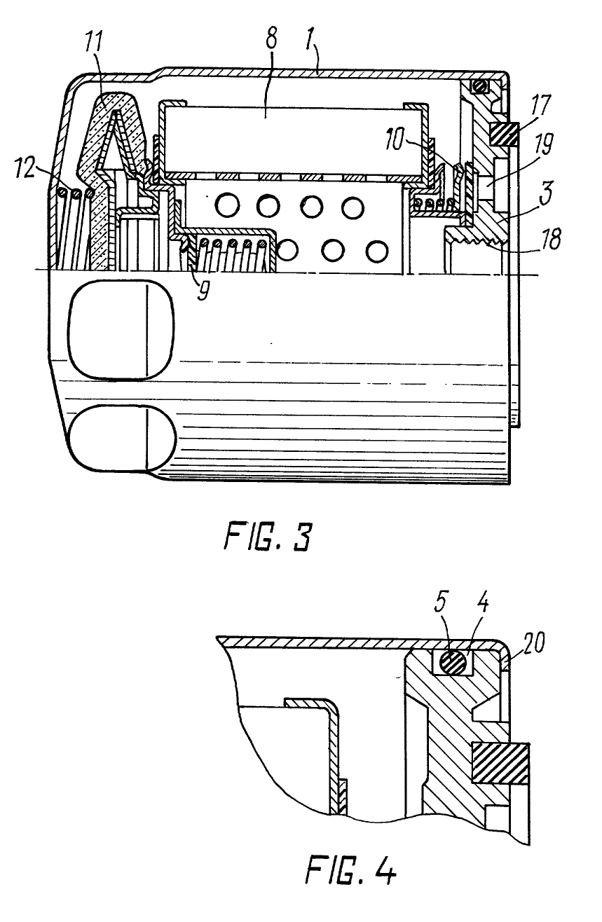

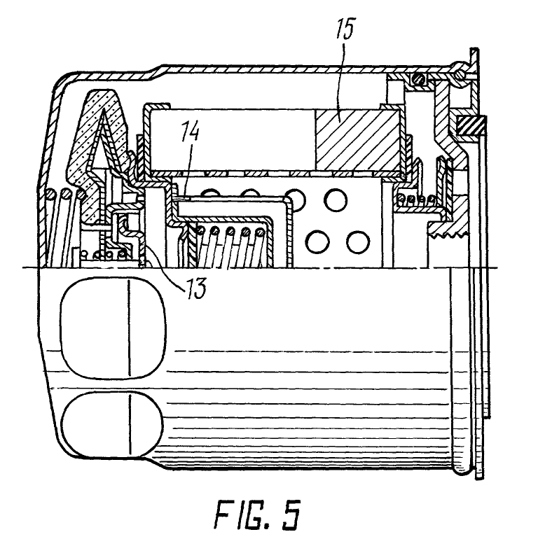

The oil cleaning filter of the invention comprises a body 1 (FIGS. 1, 2) with an annular groove 2 at the end edge thereof, a cover 3 on the external cylindrical surface of which an annular groove 4 with a sealing gasket 5 and a projection 6 is disposed, the projection 6 interacting with a split locking ring 7 disposed in the annular groove 2 of the body 1. If required, one, two and more annular grooves can be provided in the cover, with the corresponding number of sealing gaskets. The body 1 accommodates main filtering element 8 with a bypass valve 9, an anti-drain valve 10, a filtering element 11 of the bypass valve and a spring 12. The filtering element 11 of the bypass valve can be provided with a safety valve 13 with a gauze filter 14. The main filtering element 8 can be made with an additional parallel-flow filtering element 15.

The end edge of the body 1 of the filter, where the annular groove is disposed, can be reinforced with a beading 16.

In the cover 3 on the external end surface thereof there are disposed a gasket 17 for sealing the filter with the engine block, a central threaded opening 19 and openings 19 for the passage of oil.

The cross-sectional configuration of the split locking ring 7 can be round, rectangular, or represent any other combinations of solids of revolution and planes, with one tab, two tabs or no tabs bent away at their ends, with rifflings of different kind and without them.

Given hereinbelow is an example of assembling a knock-down structure of the filter.

The main filtering element 8 with a parallel-flow filtering element 15, a bypass valve 9 with a gauze filter 14, a filtering element of the bypass valve with a safety valve 13 and a spring 12 are arranged in the body 1 so that the spring 12 should thrust against the bottom of the body 1; a cover 3 having an annular groove 4, a projection 6, a central threaded opening 18 and openings 19 for the passage of oil, with an anti-drain valve 10, sealing gaskets 5 and 17 are installed inside the body so that the split locking ring could be arranged in the annular groove 2 of the body 1 having an end edge reinforced with a beading 16. Then the cover is arranged in such a manner that it should thrust with its projection 6 against the split ring 7 and become fixed.

The oil cleaning filter operates in the following manner.

Oil from the pump of the engine through the openings 19 in the cover 3 having the sealing gasket 17 for sealing the connection of the cover to the engine block, having forced down the anti-drain valve 10, enters the filter between the internal wall of the body 1 and the external surface of the filtering element 8 and the filtering element 11 of the bypass valve interacting with the spring 12. Passing through the main filtering element 8, oil becomes cleaned and comes to the main line of the engine trough a central connecting opening 18 provided in place where the filter is secured to the engine. If the additional filtering element 15 is provided, a parallel oil flow is subjected simultaneously to additional cleaning with filtering fineness amounting to 39-50% of the rated filtering fineness of the main filtering element. If the engine is cold and the main filtering element 8 is fouled, the bypass valve comes into play and bypasses the oil preliminarily cleaned by the filtering element 11 of the bypass valve to the main line of the engine. With the cover 3 is installed in the body 1, the projection 6 interacting with the split locking ring 7 thrusts against it and simultaneously locks it in the annular groove 2 of the body 1, providing thereby reliable connection of the cover 3 with the body 1 whose end edge is reinforced with the beading 16. The sealing gasket 5 disposed in the annular groove of the cover 3, interacting with the internal surface of the body 1, provides reliable tightening of the filter.

The split locking ring 7 can have a riffled surface and bent away tabs at the ends, which prevent turning of the body 1 with respect to the cover 3 of the filter.

When the main filtering element 8 and the filtering element 11 of the bypass valve are clogged, the safety valve 13 opens and passes non-cleaned oil through the interior of the filtering element of the bypass valve, the oil then going through the bypass valve 9 and the gauze filter 14 to the main line of the engine.

The proposed filter having a knock-down or a one-piece structure is noted for extreme simplicity of dismantling thereof: it will suffice to bring the cover down into the body to the height of the projection, to remove the split locking ring from the annular groove of the body, to remove the cover from the body, to take out all the component parts from the body, to sort out the parts into those made of metal, paper, rubber, to separate and gather oil. This provides the possibility of rapid and adequate utilization of the spent parts of the filter and makes the filter ecologically safe, enables reuse of the filter body, cover and other parts and units which are not worn out and fit for further functioning.

In the one-piece variant of the filter structure, it will suffice to bring the cover down into the body, while expanding its end edge, so that the cover could be freely removed from the body.

Filters having such a structure are simple to manufacture and can be rapidly assembled and dismantled. This enables automation of the process of utilization, gathering spent oil and spent filtering elements, selecting parts and units fit for further use. The filter structures wherein an additional parallel-flow filtering element is installed provide additional cleaning of oil, which adds materially to the service life of the engine.

The proposed structures of the filter can be manufactured under industrial conditions.

1. An oil cleaning filter comprising:
a body having an end edge;
a cover connected with said body, said cover having an external cylindrical surface;
a first filtering element disposed in said body;
a bypass valve of said first filtering element, disposed in said body;
a filtering element of said bypass valve, disposed in said body;
an anti-drain valve of said first filtering element, disposed in said body;
a spring disposed in said body;
an annular groove made in said body near said end edge;
a split locking ring disposed in said annular groove;
at least one annular groove made on said external surface of said cover;
at least one sealing gasket disposed in said at least one annular groove;
a projection made on said external surface of said cover and interacting with said split locking ring.

2. An oil cleaning filter according to claim 1, wherein said filtering element of said bypass valve comprises a safety valve.

3. An oil cleaning filter according to claim 1, which is provided with a second parallel-flow filtering element whose filtering fineness amounts to 39-50% of the rated filtering fineness of said first filtering element.

4. An oil cleaning filter comprising:
a body having an end cover;
a cover connected with said body, having an external cylindrical surface;
a first filtering element arranged coaxially in said body;
a bypass valve of said first filtering element, disposed in said body;
a filtering element of said bypass valve, disposed in said body;
an anti-drain valve of said first filtering element, disposed in said body;
a spring disposed in said body;
a beading of said body, made near said end edge, directed toward the interior of said body;
at least one annular groove made on said external cylindrical surface of said cover;
at least one sealing gasket disposed in said at least one annular groove of said cover;
an external end surface of said cover, interacting with said beading of said body.

5. An oil cleaning filter according to claim 4, wherein said filtering element of said bypass valve comprises a safety valve.

6. An oil cleaning filter according to claim 4, which is provided with a second parallel-flow filtering element whose filtering fineness amounts to 39-50% of the rated filtering fineness of said first filtering element.
